(19) United States
(12) Patent Application Publication
(10) Pub. No.: US 2024/0312003 A1
(43) Pub. Date: Sep. 19, 2024

(54) DEVICE FOR OPTICALLY CONTROLLING A MARK OR A DEFECT ON A CABLE OR AN EXTRUDED BODY OF GREAT LENGHT, CONTROL ASSEMBLY AND METHOD

(71) Applicant: LASERTECNO S.R.L., Bergamo (IT)

(72) Inventor: Steve ZANOLI, Bergamo (IT)

(21) Appl. No.: 18/681,438

(22) PCT Filed: Aug. 9, 2022
(86) PCT No.: PCT/IB2022/057406

§ 371 Date: Feb. 5, 2024

(30) Foreign Application Priority Data
Aug. 10, 2021 (IT) 102021000021650
Aug. 10, 2021 (IT) 102021000021662

(51) Int. Cl. G06T 7/00; B41J 3/407; B41J 11/00; B41J 15/04; G01N 21/88

(52) U.S. Cl. CPC G06T 7/001; B41J 3/40731; B41J 3/40733; B41J 11/0095; B41J 15/046; G01N 21/8851; G06T 2207/30108; G06T 2207/30204

(57) ABSTRACT

A device for optically controlling a defect or a mark on a cable or an extruded body has a supporting guide arranged close to the cable or the extruded body in a manner spaced apart therefrom. The device has an optical assembly for acquiring or reconstructing an image of a portion of the cable or extruded body at the defect or mark that is engaged to the supporting guide and movable along a curvilinear trajectory. A first motor moves the optical assembly along the curvilinear trajectory. An electronic control unit starts acquisition of the image of the portion of the cable or extruded body by the optical assembly and processes the image to extract information relative to the defect or mark. A method for optically controlling a mark or defect applied to the cable or extruded body involves comparing reference information stored on the electronic unit with current information about an extracted mark or defect from the acquired image.

The present invention relates, in general, to control systems of marks applied to cables, ropes, or extruded bodies of great length, such as pipes or rods, during the step of producing such objects, i.e., when the object to be controlled is in motion.

According to a further aspect, the present invention relates, in general, to control systems of defects on an outer surface of extruded or laminated bodies of great length, such as cables, ropes, tubes, rods, different material laminates, during the step of producing such objects, i.e., when the object to be controlled is in motion.

In particular, the present invention relates to a device for optically controlling a mark on a cable or extruded body of great length and to a method for controlling a mark thereof.

According to a further aspect, the present invention further relates to a device for optically controlling a defect on an outer surface of extruded or laminated bodies of great lengths and to a method for controlling a defect thereof.

In the step of producing extruded or laminated bodies of great lengths, such as wires or cables, the need is known to check the quality of the extruded or laminated body to identify defects on the outer surface of the body and to detect defects of a possible mark applied to said outer surface of the body. For example, in the case of wires or cables, it is known to apply an appropriate mark to the outer sheath of the cable or rope, e.g., such as an alphanumeric code, which is adapted to identify the product and/or the production batch and/or given specific characteristics.

The mark is printed on the cable as it runs at high speeds to then be wound onto respective reels.

Inconveniently, on extruded or laminated body production lines, as well as on high-speed marking lines, production defects may be found on the outer surface (holes, depressions, bumps, scratches, etc.) or the mark may decay due to problems in the marking machine print head, e.g., in the inkjet print head or the marking wheel, or due to undesired elongation or twisting of the cable or due to the depletion of the ink.

In such cases, the operator often notices the manufacturing or mark defect too late or even fails to even notice the error, resulting in the need to discard huge quantities of product due to incorrect or incomplete identification of the defect or decayed mark. Furthermore, in all these cases, the production or product marking line must be interrupted resulting in production inefficiencies.

Therefore, the need is strongly felt to suggest a device and method for controlling a mark, which can overcome the aforesaid drawbacks related to marking lines, and in particular, which can ensure timely identification of mark defects while not hindering the marking line at the same time. Therefore, according to an aspect of the invention, a need is felt for a mark control device, which is as compact as possible, easy to install on the line without requiring interruptions of the line itself, and is highly effective in identifying mark defects.

According to a further aspect, the need is strongly felt to suggest a device and method for controlling a mark which can overcome the aforesaid drawbacks related to production and marking lines, and in particular which can ensure timely identification of mark defects while at the same time not hindering the marking line. Therefore, according to an aspect of the invention, the need is felt for a mark control device, which is as compact as possible, easy to install on the line without requiring line breaks, and highly effective in identifying defects.

The aforesaid requirements are met by a device for optically controlling a mark, a device for optically controlling a device, a control assembly, and an optical control method according to the attached independent claims. The dependent claims describe preferred or advantageous embodiments.

However, the features and advantages of the device for optically controlling a mark, the device for optically controlling a defect, the control assembly, and the optical control method will be apparent from the description below of their preferred examples of embodiment, given by way of non-limiting example, with reference to the accompanying figures, in which:

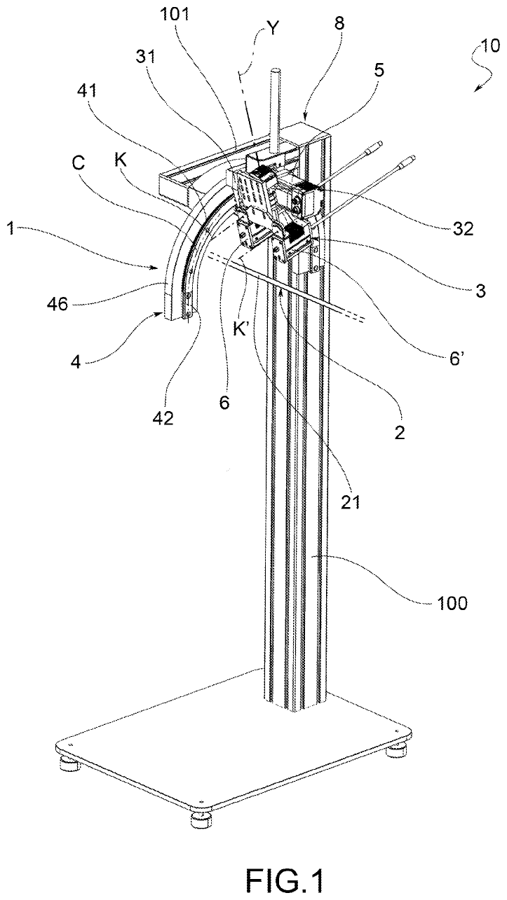

FIG. 1 shows an axonometric view of a device for optically controlling a mark or optically controlling a defect on an outer surface of an extruded or laminated body, according to an embodiment of the present invention;

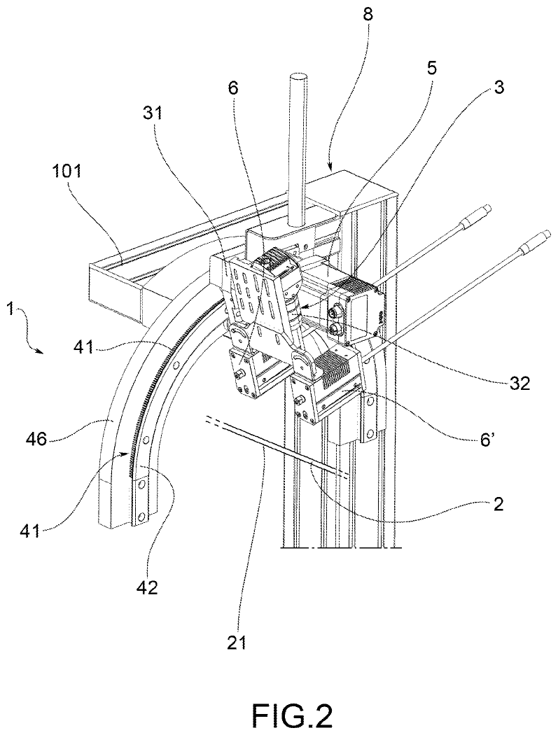

FIG. 2 shows a close axonometric view of the device for optically controlling a mark in FIG. 1;

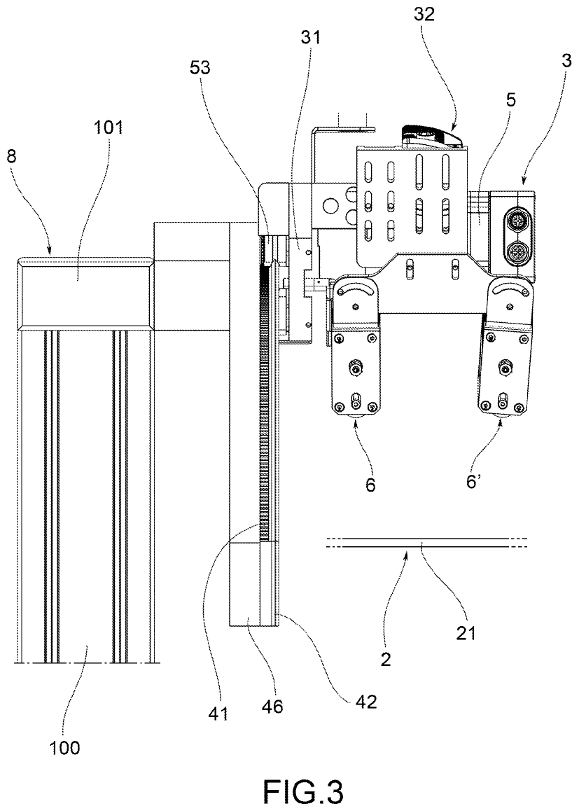

FIG. 3 shows a planar side view of the device for optically controlling a mark or defect in FIG. 2;

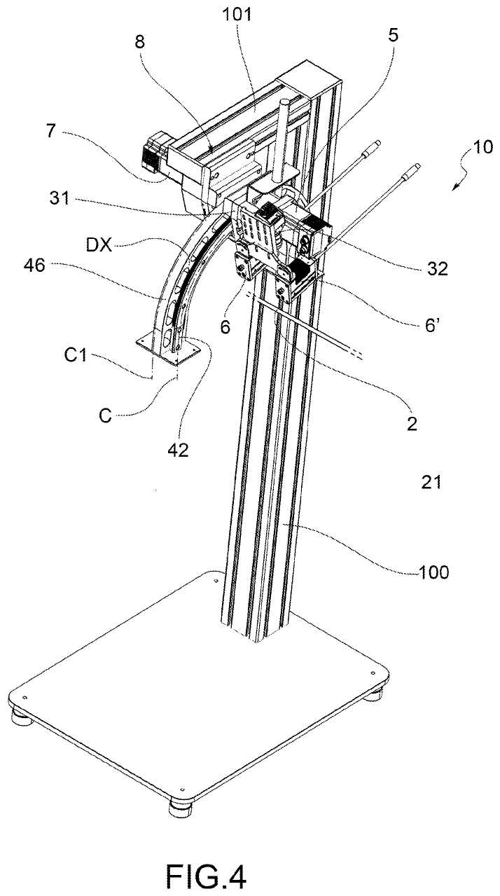

FIG. 4 shows an axonometric view of a device for optically controlling a mark or defect on an outer surface of an extruded or laminated body, according to a second embodiment of the present invention;

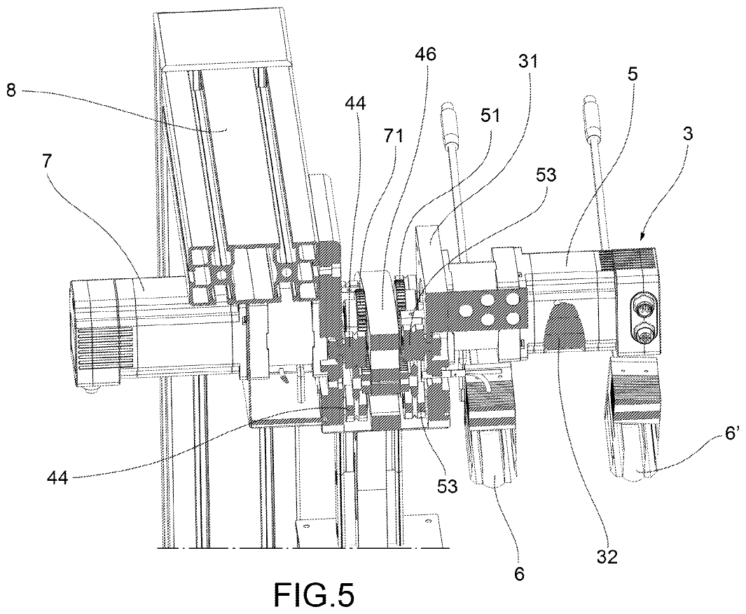

FIG. 5 shows a partial section axonometric view of the device for optically controlling a mark or a defect in FIG. 4;

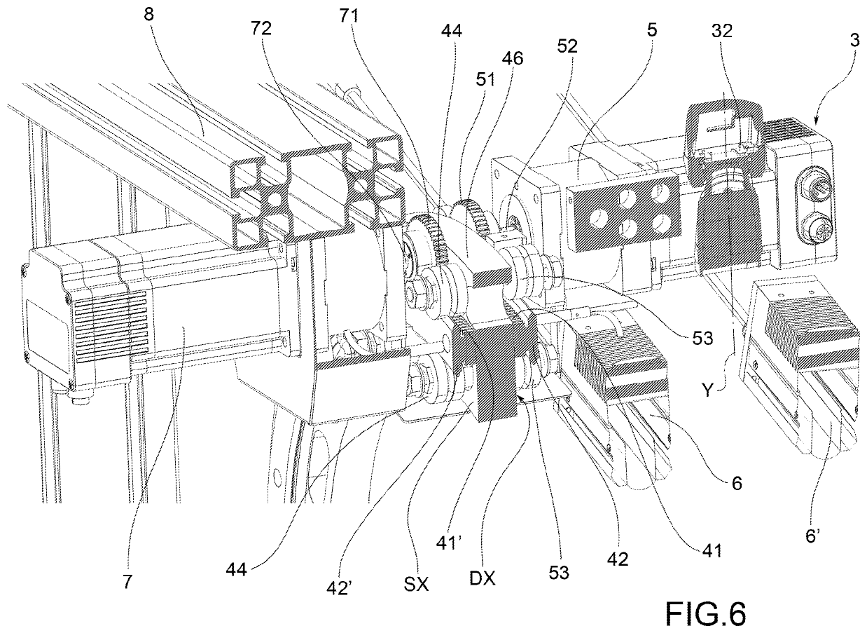

FIG. 6 shows a further partial section axonometric view of the device for optically controlling a mark or defect in FIG. 4, in which some covering casings were removed to see the guide sliding members;

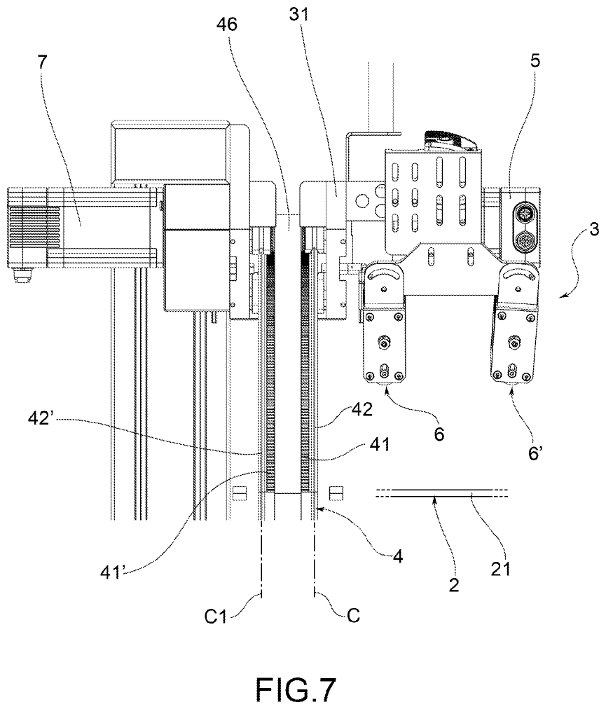

FIG. 7 shows a planar side view of an enlargement of the device for optically controlling a mark or defect in FIG. 4;

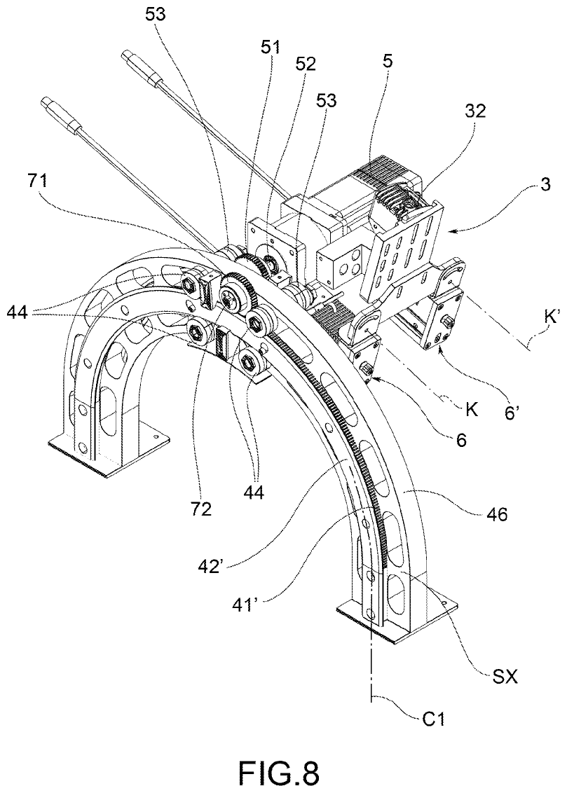

FIG. 8 shows an axonometric view of the device for optically controlling a mark or defect in FIG. 4, in which some parts, in particular the second motor, have been virtually removed for the sake of clarity of exposition;

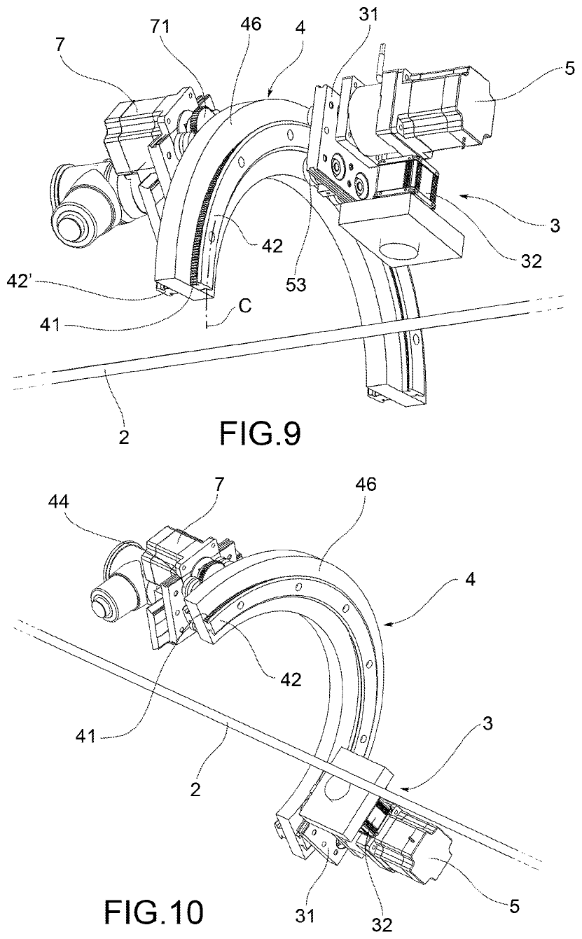

FIG. 9 shows an axonometric view of a device for optically controlling a mark or defect according to an embodiment of the present invention in an initial working configuration about an extruded or laminated cable or body;

FIG. 10 shows an axonometric view of a device for optically controlling a mark or defect according to an embodiment of the present invention in a second working configuration about an extruded or laminated cable or body, rotated relative to the first configuration shown in FIG. 9.

With reference to the aforesaid figures, a device for optically controlling a mark on a cable 2 or an extruded body of huge length is indicated by reference numeral 1 as a whole.

Without loss of clarity, the same reference numeral 1 also refers to a device for optically controlling a defect on an outer surface of an extruded or laminated body 2 of huge length. Indeed, as will be appreciated later in this discussion, the device for optically controlling a mark and the device for optically controlling a defect share the same technical features which will be described below, except that each device is intended to recognize a mark and a defect, respectively.

Therefore, in the remainder of this discussion, when reference is made in general to a device 1, it will be understood equivalently and independently to mean both a device for optically controlling a mark and a device for optically controlling a defect, unless otherwise specified.

Extruded or laminated body of great or huge length means, for example, an extruded or laminated body having a main extension of at least a few meters or tens of meters, up to even several thousand meters, e.g., such as cables, wires, pipes, rods, and the like, made by extrusion or lamination on large lines and requiring in-line quality control and/or marks applied at high mark speeds.

Defect means, for example, a hole or a depression or a bump or a scratch or an excess of material or a lack of material, or in the case of plotting machines a difference in a pattern or a lack of pattern, on the outer surface of the extruded or laminated body.

Mark means a mark applied to the outer surface of the cable or extruded body, typically by printing, etching, or photoengraving, at a high speed, such as exceeding a sliding speed of the cable or extruded body even on the order of one thousand two hundred meters per minute (20 m/s).

According to the invention, the device 1 comprises a supporting guide 4 adapted to be arranged close to the cable 2 or extruded body, and an optical assembly 3 adapted to acquire or reconstruct an image of a portion 21 of the cable or extruded body at a mark provided on the cable 2.

The optical assembly 3 is engaged to the supporting guide 4 to be movable along a curvilinear trajectory C about the cable 2 or the extruded body.

The device 1 also comprises a first motor 5, operatively connected to the supporting guide 4, to move the optical assembly 3 along the curvilinear trajectory C.

Furthermore, the device 1 comprises an electronic control unit (not shown in the accompanying figures), operatively connected to the optical assembly 3 and first motor 5, configured to activate the image acquisition of the portion of cable 21 or extruded body by optical assembly 3. Furthermore, the electronic control unit is configured to process the image of the portion of cable 21 or extruded body to extract information related to the mark. Said information about the mark is, for example, an image of the mark itself, or processing of the mark image, e.g., segmentation, or encoding, or parameterization of the mark image.

According to an embodiment of the invention, the optical assembly 3 comprises a camera 32 and a supporting member 31, e.g. a plate. The camera 32 and the first motor 5 are integral in motion with the supporting member 31, e.g., they are fixed thereto. The supporting member 31 slides in motion along the supporting guide 4 to be moved along the curvilinear trajectory C. Therefore, the movement of the supporting member 31 comprises the consequent movement of the optical assembly 3 and the first motor 5.

Preferably, the curvilinear trajectory C is a circular trajectory or a semicircular trajectory or a circular portion trajectory.

In particular, preferably, the supporting guide 4 comprises a supporting plate 46 with a circular or semicircular portion geometry. This makes it possible to obtain a device, which is easy to make and compact.

According to an embodiment, the supporting guide 4 comprises a first curvilinear rack 41 and a sliding guide 42, e.g. a rail. In this variant, the device 1 comprises a pinion 51 kinematically connected to a first drive shaft 52 of the first motor 5. The same pinion 51 is engaged at the rack 41 to move the optical assembly 3 along the sliding guide 42.

Preferably, the optical assembly 3 comprises sliding members 53, e.g., skids or rollers, adapted to be engaged with the sliding guide 42 to slidingly support the optical assembly 3. In particular, the sliding members 53 fully and exclusively support the optical assembly 3 on the sliding guide 42, so that the optical assembly appears to be supported cantilevered only by the mechanical coupling between the sliding members and the sliding guide.

According to an advantageous embodiment, the optical assembly 3 comprises one or more lighting devices 6, 6′ supported by the supporting member 31 and adapted to illuminate the portion of cable or extruded body.

Preferably, the lighting devices are arranged around the camera 32.

According to an embodiment, the lighting devices 6, 6′ are supported by the supporting member in a rotatable manner about a lighting device rotation axis K, K′. Preferably, said lighting device rotation axis K, K′ is an axis perpendicular to the optical axis Y of the camera 32. This makes it possible to adjust the lighting devices properly to avoid poor lighting or shadow effects, especially near the edges of the cable or extruded or laminated body.

Preferably, the lighting devices are LED lighting devices, comprising focal lenses adapted to focus the emitted light at the focus point of the camera 32.

According to an embodiment, the lighting devices are configured to receive a synchronization signal from the electronic control unit so that the lighting is activated when the image is acquired by the camera 32. This allows avoiding overheating the lighting devices 6, 6′ and prolonging their service life.

According to another embodiment, the lighting devices are configured to be constantly switched on continuously. This is particularly suitable in conditions of high image acquisition frequency by the camera 32, to avoid phenomena of low light or shadowing of the extruded or laminated cable or body.

According to an embodiment, e.g., shown in FIGS. 1 to 3, the supporting guide 4 is connected to a supporting structure 8 either in a fixed manner or by means of a connecting joint, preferably a lockable ball joint so that the position of the supporting guide 4 can be oriented in space.

10 According to a variant embodiment, e.g., shown in FIGS. 4 to 10, the device 1 comprises a second motor 7. In this variant, the supporting guide is not directly fixedly connected to the supporting structure, but the second motor 7 is adapted to be solidly connected to the supporting structure 8. Said second motor 7 is operationally connected to the supporting guide 4 to move it along a second curvilinear trajectory C1, i.e., to rotate or roto-translate it relative to the supporting structure 8. Consequently, the optical assembly 3 is also moved along such a second curvilinear trajectory C1. Preferably, the second curvilinear trajectory C1 is a curvilinear trajectory either parallel to or coincident with the curvilinear trajectory C. Even more preferably, the second curvilinear trajectory C1 is a trajectory of the same shape as the curvilinear trajectory C.

Preferably, the supporting guide 4 comprises a second curvilinear rack 41′ and a second sliding guide 42′, e.g., a rail, preferably also curvilinear.

Preferably, the device 1 comprises a second pinion 71 kinematically connected to a second motor shaft 72 of said second motor 7. The second pinion 71 is engaged at the second rack 41′ to move the supporting guide 4 along the second curvilinear trajectory C1.

Preferably, the device 1 comprises guide sliding members 44, e.g., skids and/or rollers, adapted to be integrally fixed to the supporting structure 8 and engaged with the second sliding guide 42′ to slidingly support the supporting guide 4.

According to an embodiment, e.g., shown in FIGS. 4 to 10, supporting guide 4 comprises a supporting plate 46 in the shape of a circular sector. The first curvilinear rack 41 and the sliding guide 42 are fixed on the right side DX of said supporting plate 46. The second rack 41′ and the second sliding guide 42′ are fixed to a left side SX of said supporting plate 46, opposite to the right side DX. This allows a device to be obtained, which is easy to manufacture, compact, accurate, and robust over time. Furthermore, it allows moving the optical assembly 3 about the cable for the entire circumference, from 0° to 360°, while maintaining easy installation of the device 1 around the cable or the extruded body or laminated body, without the need to interrupt the continuity of the cable, or stop the line, or provide for opening and closing operations of the guide (which would be necessary if the support guide 4 were entirely circular).

Thus, advantageously, due to the geometry of the supporting plate 46, it is possible to take the device into a working configuration without having to make structural changes to the device and without assembling or disassembling device components. Preferably, the first motor 5 is arranged on the right side DX, while the second motor 7 is arranged on the left side SX.

According to an embodiment, the electronic control unit comprises storage means configured to store reference information (template) of a defect or mark, e.g., an image of a figurative sign or an image of an alphanumeric code. The electronic unit is configured to compare the reference information with the current mark information extracted from the image acquired by the optical assembly 3 to calculate data related to the discrepancy between such reference information and such current mark or defect information extracted from the image acquired by the optical assembly 3. In this manner, the device can determine whether the mark or defect on the cable 2 or extruded or laminated body conforms to a desired or acceptable reference mark or defect or deviates within given predetermined conformity limits. If the detected mark or defect is outside the predetermined acceptable limits, the electronic unit generates a warning signal, visual and/or audible, adapted to be later provided to an operator or to a control machine, responsible for making appropriate decisions, such as adjusting the print head or other process parameters of the production or mark line.

It is a further object of the present invention to provide a control assembly 10 for optically controlling a defect or mark on a cable 2 or extruded or laminated body of huge length. The assembly comprises a device 1 as described in the previous sections of this discussion and a supporting structure 8. The supporting structure 8 comprises an upright element 100 and a supporting arm 101 which protrudes from the upright element 100 in a direction incident to the upright element 100. The supporting arm 101 is connected to the supporting guide 4 or the second motor 7 to facilitate the installation of the control assembly 10 near the cable 2 or extruded body with minimum clearance on the running line of the cable 2 or extruded or laminated body.

It is a further object of the present invention to provide a method for optically controlling a defect or mark on a cable 2 or extruded or laminated body of huge length.

The method comprising the operational steps of:
a) providing a device 1 for optically controlling a defect or a mark, preferably a device 1 as described in the present invention, comprising:
   a supporting guide 4 arranged close to the cable 2 or to the laminated or extruded body in a manner spaced apart therefrom,
   an optical assembly 3 adapted to acquire or reconstruct an image of a portion 21 of cable or extruded or laminated body at a mark provided on the cable 2 or the extruded or laminated body, said optical assembly 3 being engaged with the supporting guide 4 to be movable along a curvilinear trajectory C about the cable 2 or about the extruded or laminated body,
   a first motor 5, operatively connected to the supporting guide 4, to move the optical assembly 3 along the curvilinear trajectory C;
   an electronic control unit, configured to start the image acquisition of the portion 21 of cable or extruded or laminated body by means of the optical assembly 3 and to process the image of the portion 21 of cable or of extruded or laminated body, said electronic control unit comprising storage means on which reference information (template) of a defect or a mark is stored, such as an image of a figurative sign or an image of an alphanumeric code;
b) moving the optical assembly 3 by the first motor 5 until it reaches an angular acquisition position about the cable 2 or about the extruded or laminated body;
c) from the electronic control unit, sending an image acquisition signal of the portion of the cable 21 or of the extruded or laminated body comprising a defect or a mark;
d) on the electronic control unit, processing the image acquired in step c), calculating current mark information extracted from the acquired image, comparing the reference information stored on the electronic control unit with the current mark or defect information extracted from the image acquired by the optical assembly 3, and calculating data related to the discrepancy between said reference information and said current detect or mark information extracted from the image acquired by the optical assembly 3.

According to an embodiment, the method provides that step b) comprises the sequence of the following operational calibration steps:

b1) moving the optical assembly 3 by the first motor 5 until it reaches an angular calibration position about the cable 2 or about the extruded or laminated body;
b2) from the electronic control unit, sending an image acquisition signal of the portion of the cable 2 or of the extruded or laminated body;
b3) on the electronic unit, processing the image acquired in step b2) and verifying the presence of an image of the mark or defect on said acquired image;
b4) sequentially repeating the steps from b1) to b3) until the acquired image contains a complete image of the mark or of the defect to be controlled,
b5) storing the last angular calibration position considered in step b1) as the angular acquisition position.

According to this variant, the method first allows identifying the correct position of the optical assembly 3 about the cable to identify where the mark or defect is located on the cable or on the extruded or laminated body, and then the continuous acquisition of the defect or mark and control begins.

From the aforesaid description of steps b) and c) of the method, it is apparent and can be inferred that during step c) it is provided to acquire the entire image of the mark or defect to be inspected on the portion of cable 21 or extruded or laminated body which contains the defect or mark, when the optical assembly 3 is fixed in the reached angular acquisition position about the cable 2 or the extruded or laminated body, i.e. when optical assembly 3 is not moving.

Furthermore, the method allows the optical assembly 3 to be moved further by the first motor 5 and/or the second motor 7 even after an initial calibration step, if the mark or defect moves from an initial calibration position identified for acquisition, updating the acquisition position of the optical assembly over time. This allows the position of the mark or defect to be continuously “tracked”.

Innovatively, the present invention allows brilliantly overcoming the aforesaid drawbacks regarding quality or mark control on the known production lines of extruded or laminated bodies or the marking lines of extruded or rolled cables or bodies.

In particular, by virtue of the presence of a device which is easy to install on the line about the cable or extruded or laminated body, with an optical assembly which can be moved about the cable or body simply, it is possible to keep the quality of the outer surface of the extruded/laminated body or the mark on that outer surface constantly monitored, even on lines with high running speed and to detect the decay of production or mark quality or to detect a marking error in a timely manner.

Furthermore, due to the controlled step-by-step movement of the position of the optical assembly 3 about the cable or the extruded or laminated body, it is possible to track any change in the position of the mark or defect around the cable or the extruded or laminated body over time, without the need to move the internal device, and by simply remotely controlling the first and/or second motor. This is particularly useful where the position of the defect or mark rotates relative to the optical assembly due to the twisting of the cable 2 or the extruded or laminated body along the line.

In a particularly advantageous manner, the embodiment with two motors and a single supporting guide moved by one of the motors allows the optical assembly to be moved around the cable 2 or extruded body from 0° to 360° while having a supporting guide that extends circumferentially for only a portion of the entire circumference around the cable or extruded or laminated body. This advantageously allows reaching and acquiring images all around the cable or body, but without having to involve opening/closing operations of the guide so that the extruded or laminated cable or body can be positioned within the circumference of the guide. Furthermore, it is not necessary to interrupt the continuity of the extruded or laminated cable or body to place the device around the extruded or laminated cable or body or to constrain the cable or body within a totally enclosed device which is difficult to access for controlling.

To meet specific requirements, a person skilled in the art may make variants or replace elements with other functionally equivalent ones to the embodiments of the present invention.

Such variants are also included in the scope of protection as defined by the following claims.

1. A device for optically controlling a mark on a cable or an extruded body of huge length, said device comprising:
a supporting guide adapted to be arranged close to the cable or the extruded body in a manner spaced apart therefrom;
an optical assembly adapted to acquire or reconstruct an image of a portion of cable or extruded body at a mark provided on the cable, said optical assembly being engaged with the supporting guide so as to be movable along a curvilinear trajectory or the extruded body,
a first motor, operatively connected to the supporting guide, to move the optical assembly along the curvilinear trajectory; and
an electronic control unit, configured to start acquisition of the image of the portion of cable or extruded body by the optical assembly and to process the image of the portion of cable or extruded body to extract mark information.

2. The device of claim 1, wherein the optical assembly comprises a camera and a supporting member, the supporting member optionally being a plate,
wherein the camera and the first motor are integral in motion with the supporting member,
and wherein the supporting member slides in motion along the supporting guide to be moved along the curvilinear trajectory.

3. The device of claim 1, wherein the curvilinear trajectory is a circular or semicircular trajectory.

4. The device of claim 1, wherein the supporting guide comprises a supporting plate with a circular or semicircular portion geometry.

5. The device of claim 1, wherein the supporting guide comprises a first curvilinear rack and a sliding guide, the sliding guide optionally being a rail,
wherein the device further comprises a pinion kinematically connected to a first motor shaft of said first motor and engaged with said first curvilinear rack to move the optical assembly along the sliding guide,
and wherein the optical assembly comprises sliding members, the sliding members optionally being skids or rollers, adapted to be engaged with the sliding guide to slidingly support the optical assembly.

6. The device of claim 2, wherein the optical assembly further comprises one or more lighting devices, supported by the supporting member and adapted to illuminate the portion of cable or extruded body.

7. The device of claim 1, further comprising a second motor adapted to be integrally connected to a supporting structure of the device, said second motor being operatively connected to the supporting guide to move said supporting guide along a second curvilinear trajectory with respect to the supporting structure and, consequently, to move the optical assembly along said second curvilinear trajectory as well.

8. The device of claim 7, wherein the supporting guide comprises a second curvilinear rack and a second sliding guide the second sliding guide optionally being a rail,
wherein the device comprises a second pinion kinematically connected to a second motor shaft of said second motor and engaged with said second curvilinear rack to move the supporting guide along the second curvilinear trajectory,
and wherein the device further comprises guide sliding members, the guide sliding members optionally being skids or rollers, adapted to be integrally fixed to the supporting structure and engaged with the second sliding guide to slidingly support the supporting guide.

9. The device of claim 8, wherein the supporting guide further comprises a supporting plate shaped as a circular sector, wherein the first curvilinear rack and the sliding guide are fixed to a right side of said supporting plate,
wherein the second curvilinear rack and the second sliding guide are fixed to a left side of said supporting plate, opposite to the right side,
and wherein the first motor is arranged on the right side, while the second motor is arranged on the left side.

10. The device of claim 1, wherein the electronic control unit comprises storage means configured to store reference information of the mark,
and wherein said electronic unit is configured to compare the reference information with current mark information extracted from the image acquired by the optical assembly and to calculate data related to a discrepancy between said reference information and said current mark information extracted from the image acquired by the optical assembly.

11. A control assembly for optically controlling a mark on a cable or an extruded body of huge length, comprising the device of claim 1 and a supporting structure comprising an upright element and a supporting arm protruding from the upright element in a direction incident to the upright element, said supporting arm being connected to the supporting guide or to a second motor of the device to facilitate installation of the control assembly close to the cable or the extruded body with minimum hindrance for a sliding system of the cable or the extruded body.

12. A method for optically controlling a mark applied to a cable or an extruded body of huge length, said method comprising:
(a) providing a device for optically controlling the mark comprising:
a supporting guide arranged close to the cable or the extruded body in a manner spaced apart therefrom,
an optical assembly adapted to acquire or reconstruct an image of a portion of cable or extruded body at a mark provided on the cable or the extruded body, said optical assembly being engaged with the supporting guide to be movable along a curvilinear trajectory about the cable or the extruded body,
a first motor, operatively connected to the supporting guide, to move the optical assembly along the curvilinear trajectory; and
an electronic control unit, configured to start acquisition of the image of the portion of cable or extruded body by the optical assembly and to process the image of the portion of cable or extruded body, said electronic control unit comprising storage means on which reference information of the mark is stored;
(b) moving the optical assembly by the first motor until the optical assembly reaches an angular acquisition position about the cable or the extruded body;
(c) from the electronic unit, sending an image acquisition signal of the portion of the cable or extruded body comprising the mark; and
(d) on the electronic unit, processing the image acquired in step, calculating current mark information extracted from the acquired image, comparing the reference information stored on the electronic unit with the current mark information extracted from the image acquired by the optical assembly, and calculating data related to a discrepancy between said reference information and said current mark information extracted from the image acquired by the optical assembly.

13. The method of claim 12, wherein step (b) comprises the sequence of the following steps:
(b1) moving the optical assembly by the first motor until the optical assembly reaches an angular calibration position about the cable or the extruded body;
(b2) from the electronic unit, sending an image acquisition signal of the portion of the cable or extruded body;
(b3) on the electronic unit, processing the image acquired in step (b2) and verifying a presence of an image of the mark on said acquired image;
(b4) sequentially repeating the steps from (b1) to (b3) until the acquired image contains a complete image of the mark to be controlled, and
(b5) storing the angular calibration position considered in step (b1) as the angular acquisition position.

14. A device for optically controlling a defect on an outer surface of an extruded or laminated body of huge length, said device comprising:
a supporting guide adapted to be arranged close to the extruded or laminated body in a manner spaced apart therefrom;
an optical assembly adapted to acquire or reconstruct an image of a portion of the extruded or laminated body at a defect on the extruded or laminated body, said optical assembly being engaged with the supporting guide so as to be movable along a curvilinear trajectory about the extruded or laminated body,
a first motor, operatively connected to the supporting guide, to move the optical assembly along the curvilinear trajectory; and
an electronic control unit, configured to start acquisition of the image of the portion of the extruded or laminated body by the optical assembly and to process the image of the portion of the extruded or laminated body to extract defect information.

15. The device of claim 14, wherein the optical assembly comprises a camera and a supporting member, the supporting member optionally being a plate,
wherein the camera and the first motor are integral in motion with the supporting member,
and wherein the supporting member slides in motion along the supporting guide to be moved along the curvilinear trajectory.

16. The device of claim 14, wherein the curvilinear trajectory is a circular or semicircular trajectory.

17. The device of claim 14, wherein the supporting guide comprises a supporting plate with a circular or semicircular portion geometry.

18. The device of claim 14, wherein the supporting guide comprises a first curvilinear rack and a sliding guide, optionally the sliding guide being a rail,
wherein the device further comprises a pinion kinematically connected to a first motor shaft of said first motor and engaged with said first curvilinear rack to move the optical assembly along the sliding guide,
and wherein the optical assembly comprises sliding members, the sliding members optionally being skids or rollers, adapted to be engaged with the sliding guide to slidingly support the optical assembly.

19. The device of claim 15, wherein the optical assembly further comprises one or more lighting devices, supported by the supporting member and adapted to illuminate the portion of the extruded or laminated body.

20. The device of claim 14, further comprising a second motor adapted to be integrally connected to a supporting structure of the device, said second motor being operatively connected to the supporting guide to move said supporting guide along a second curvilinear trajectory with respect to the supporting structure and, consequently, to move the optical assembly along said second curvilinear trajectory as well.

21. The device of claim 20, wherein the supporting guide comprises a second curvilinear rack and a second sliding guide, the second sliding guide optionally being a rail,
wherein the device further comprises a second pinion kinematically connected to a second motor shaft of said second motor and engaged with said second curvilinear rack to move the supporting guide along the second curvilinear trajectory,
and wherein the device further comprises guide sliding members, the guide sliding members optionally being skids or rollers, adapted to be integrally fixed to the supporting structure and engaged with the second sliding guide to slidingly support the supporting guide.

22. The device of claim 21, wherein the supporting guide further comprises a supporting plate shaped as a circular sector, wherein the first curvilinear rack and the sliding guide are fixed to a right side of said supporting plate,
wherein the second curvilinear rack and the second sliding guide are fixed to a left side of said supporting plate, opposite to the right side,
and wherein the first motor is arranged on the right side, while the second motor is arranged on the left side.

23. The device of claim 14, wherein the electronic control unit comprises storage means configured to store reference information of a defect or mark,
and wherein said electronic unit is configured to compare the reference information with current defect information extracted from the image acquired by the optical assembly and to calculate data related to a discrepancy between said reference information and said current defect information extracted from the image acquired by the optical assembly.

24. A control assembly for optically controlling a defect on an outer surface of an extruded or laminated body of huge length, comprising the device of claim 14 and a supporting structure comprising an upright element and a supporting arm protruding from the upright element in a direction incident to the upright element, said supporting arm being connected to the supporting guide or to a second motor of the device to facilitate installation of the control assembly close to the extruded or laminated body with minimum hindrance for a sliding system of the extruded or laminated body.

25. A method for optically controlling a defect on an outer surface of an extruded or laminated body of huge length, said method comprising:
(a) providing a device for optically controlling the defect comprising:
a supporting guide arranged close to the extruded or laminated body in a manner spaced apart therefrom,
an optical assembly adapted to acquire or reconstruct an image of a portion of the extruded or laminated body at the defect on the outer surface of the extruded or laminated body, said optical assembly being engaged with the supporting guide to be movable along a curvilinear trajectory about the extruded or laminated body,
a first motor, operatively connected to the supporting guide, to move the optical assembly along the curvilinear trajectory; and
an electronic control unit, configured to start acquisition of the image of the portion of the extruded or laminated body by the optical assembly and to process the image of the portion of the extruded or laminated body, said electronic control unit comprising storage means on which reference information of a defect or mark is stored;
(b) moving the optical assembly by the first motor until the optical assembly reaches an angular acquisition position about the extruded or laminated body;
(c) from the electronic unit, sending an image acquisition signal of the portion of the extruded or laminated body comprising the defect;
(d) on the electronic unit, processing the image acquired in step (c), calculating current defect information extracted from the acquired image, comparing the reference information stored on the electronic unit with the current defect information extracted from the image acquired by the optical assembly, and calculating data related to a discrepancy between said reference information and said current defect information extracted from the image acquired by the optical assembly.

26. The method of claim 25, wherein step (b) comprises the sequence of the following steps:
(b1) moving the optical assembly by the first motor until the optical assembly reaches an angular calibration position about the extruded or laminated body;
(b2) from the electronic unit, sending an image acquisition signal of the portion of the extruded or laminated body;
(b3) on the electronic unit, processing the image acquired in step (b2) and verifying a presence of an image of a defect on said acquired image;
(b4) sequentially repeating the steps from (b1) to (b3) until the acquired image contains a complete image of the defect to be controlled, and
(b5) storing the angular calibration position considered in step b1) as the angular acquisition position.
